(19) United States
(12) Patent Application Publication
(10) Pub. No.: US 2016/0080340 A1
(43) Pub. Date: Mar. 17, 2016

(54) COMMUNICATION CONTROL DEVICE

(71) Applicant: KABUSHIKI KAISHA TOSHIBA, Tokyo (JP)

(72) Inventors: Yoshihiro OBA, Kawasaki (JP); Yoshikazu HANATANI, Tokyo (JP)

(21) Appl. No.: 14/830,845

(22) Filed: Aug. 20, 2015

(30) Foreign Application Priority Data
Sep. 12, 2014 (JP) 2014-186637

(51) Int. Cl. H04L 29/06; H04L 9/32; H04W 12/04

(52) U.S. Cl. CPC H04L 63/065; H04W 12/04; H04L 63/08; H04L 9/3247; H04L 9/3268

(57) ABSTRACT

According to an embodiment, a communication control device includes a generation unit and a control unit. The generation unit generates, in a system using a group key block, a group key corresponding to an individual communication group formed by two communication devices by using an manipulation command including a digital signature of the communication control device. The control unit controls a group manipulation of the communication devices by using a group manipulation command message to which an authentication code according to the generated group key is attached.

### CROSS-REFERENCE TO RELATED APPLICATION(S)

This application is based upon and claims the benefit of priority from Japanese Patent Application No. 2014-186637, filed on Sep. 12, 2014; the entire contents of which are incorporated herein by reference.

### FIELD

An embodiment described herein relates generally to a communication control device.

### BACKGROUND

IEEE 802.21d/D05 uses a digital signature to perform sender authentication on a group manipulation command message transmitted from a Group Manager (GM).

The group manipulation command message is transmitted to a plurality of members according to IEEE 802.21d/D05, where it is difficult to apply message authentication using a common group key to the sender authentication. That is, the digital signature is generated and verified every time a group manipulation is performed according to IEEE 802.21d/D05, thereby causing a processing load to be increased.

### BRIEF DESCRIPTION OF THE DRAWINGS

FIG. 1 is a block diagram illustrating a configuration of a communication system according to an embodiment;

FIG. 2 is a diagram illustrating connections between controllers and devices according to the embodiment;

FIG. 3 is a table illustrating associations between node types according to the embodiment;

FIG. 4 is a block diagram illustrating a hardware configuration of devices according to the embodiment;

FIG. 5 is a block diagram illustrating a functional configuration of a coordinator according to the embodiment;

FIG. 6 is a diagram illustrating a group management tree and Leaf IDs according to the embodiment;

FIG. 7 is a diagram illustrating a group assignment rule according to the embodiment;

FIG. 8 is an overall sequence illustrating communication procedures according to the embodiment;

FIG. 9 is a diagram illustrating an authentication sequence according to the embodiment;

FIG. 10 is a diagram illustrating a key sharing sequence according to the embodiment;

FIG. 11 is a table illustrating default values of group communication security policies according to the embodiment;

FIG. 12 is a diagram illustrating resynchronization of a sequence number according to the embodiment where a participating node acts as a trigger;

FIG. 13 is a diagram illustrating resynchronization of a sequence number according to the embodiment where a coordinator acts as a trigger;

FIG. 14 is a table illustrating security-policy-independent TLVs included in MIH_Net_Group_Manipulate request messages according to the embodiment;

FIG. 15 is a table illustrating security-policy-independent TLVs included in MIH_Net_Group_Manipulate response messages according to the embodiment;

FIG. 16 is a table illustrating security-policy-independent TLVs included in MIH_MN_Group_Manipulate request messages according to the embodiment;

FIG. 17 is a table illustrating security-policy-independent TLVs included in MIH_MN_Group_Manipulate response messages according to the embodiment;

FIG. 18 is a table illustrating a security-policy-independent TLVs included in MIH_Push_Certificate request message according to the embodiment;

FIG. 19 is a table illustrating security-policy-independent TLVs included in MIH_Push_Certificate response messages according to the embodiment;

FIG. 20 is a table illustrating security-policy-independent TLVs included in MIH_Configuration_Update indication messages according to the embodiment;

FIG. 21 is a table illustrating security-policy-independent TLVs included in MIH_Revoke_Certificate request messages according to the embodiment;

FIG. 22 is a table illustrating security-policy-independent TLVs included in MIH_Revoke_Certificate response messages according to the embodiment;

FIG. 23 is a diagram illustrating a detailed sequence of a key sharing phase 1A according to the embodiment;

FIG. 24 is a diagram illustrating a detailed sequence of a key sharing phase 1B according to the embodiment;

FIG. 25 is a diagram illustrating a detailed sequence of a key sharing phase 2 according to the embodiment;

FIG. 26 is a diagram illustrating the detailed sequence of the key sharing phase 2 according to the embodiment;

FIG. 27 is a diagram illustrating a detailed sequence of encrypted communication according to the embodiment;

FIG. 28 is a diagram illustrating a detailed sequence of certificate revocation according to the embodiment; and

FIG. 29 is a diagram illustrating a detailed sequence of group key update according to the embodiment.

### DETAILED DESCRIPTION

According to an embodiment, a communication control device includes a generation unit and a control unit. The generation unit generates, in a system using a group key block, a group key corresponding to an individual communication group formed by two communication devices by using an manipulation command including a digital signature of the communication control device. The control unit controls a group manipulation of the communication devices by using a group manipulation command message to which an authentication code according to the generated group key is attached.

System Architecture

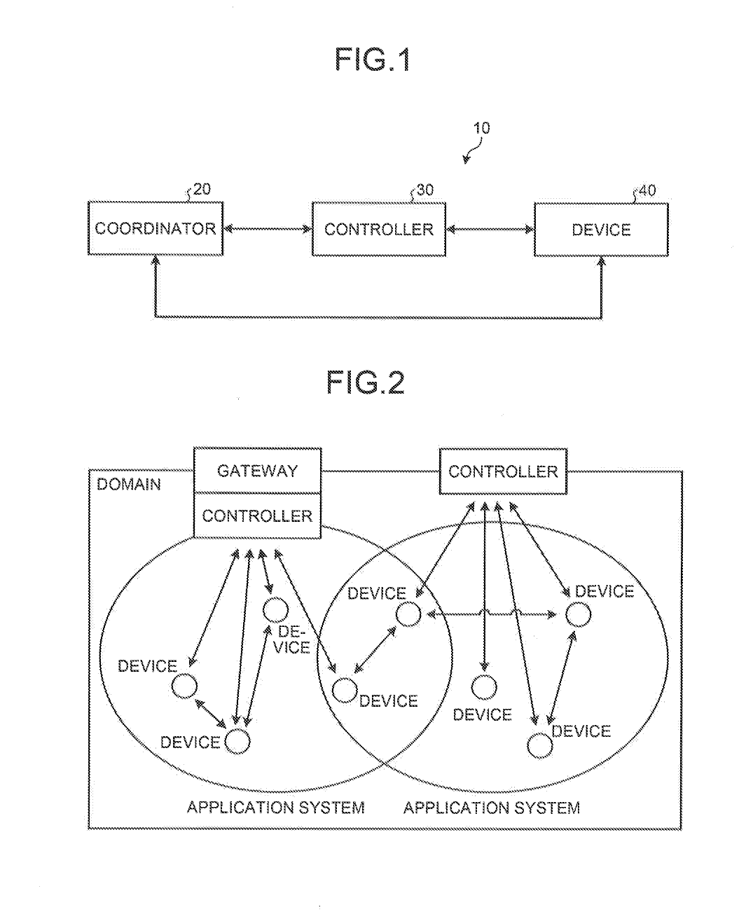

FIG. 1 is a block diagram illustrating an example of a configuration of a communication system according to an embodiment. Security functions of an ECHONET Lite node will be described as an example in the present embodiment. The ECHONET Lite node supports a protocol for carrying authentication for network access (PANA) defined according to IEEE 802.21d and RFC 5191 as the security functions.

As illustrated in FIG. 1, a communication system 10 includes a coordinator 20, a controller 30, and a device 40. Among then, the coordinator 20 is a communication control device that controls the controller 30 and the device 40 each being an example of a communication device, and one coordinator 20 is provided in one ECHONET Lite domain (hereinafter may simply referred to as a “domain”). The domain corresponds to one home area network (HAN), for example. At least one controller 30 is provided in one domain. That is, M (M≧1) controllers 30 are provided. At least one device 40 is provided in one domain. That is, N (N≧1) devices 40 are provided. FIG. 2 is a diagram illustrating connections between controllers and devices according to the embodiment. As illustrated in FIG. 2, one or more controllers 30 and one or more devices 40 are provided in one domain. A device 40 belongs to a group (an application system group) formed by the controller 30. Here, a device 40 may belong to a plurality of application system groups.

Procedures of “mutual authentication” and “key sharing” are performed between the coordinator 20 and the controllers 30. Likewise, the procedures of “mutual authentication” and “key sharing” are performed between the coordinator 20 and the devices 40. A “encrypted communication” is performed between the controllers 30 and the devices 40. Encryption keys used in the encrypted communication are distributed to the controllers 30 and the devices 40 by the coordinator 20 through the procedure of key sharing. The encrypted communication may also be performed between the controllers 30 and between the devices 40. Detailed procedures of mutual authentication, key sharing, and encrypted communication will be described later.

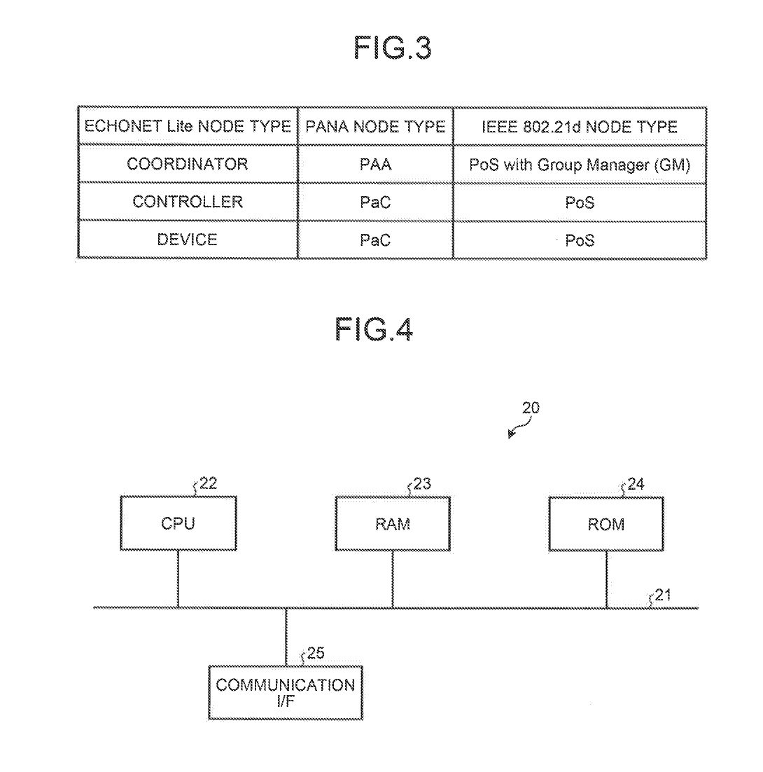

FIG. 3 is a table illustrating associations between node types according to the embodiment. FIG. 3 illustrates an example of associations between an ECHONET Lite node type, a PANA node type, and an IEEE 802.21d node type. The coordinator 20 is a node that predominantly conducts group management and security management and is defined as a new class in ECHONET Lite management and an manipulation-related device group. The controllers 30 and devices 40 are existing classes in the ECHONET Lite management and the manipulation-related device group. The coordinator 20 has functions of a PANA authentication agent (PAA) according to PANA and a point of service (PoS) with a g Group manager (GM) according to IEEE 802.21d. The controllers 30 and the devices 40 have functions of a PANA client (PaC) according to the PANA and a PoS according to IEEE 802.21d. Note that the coordinator 20 may not be an ECHONET Lite node device. The communication system according to the present embodiment can also be applied to systems other than ECHONET Lite systems.

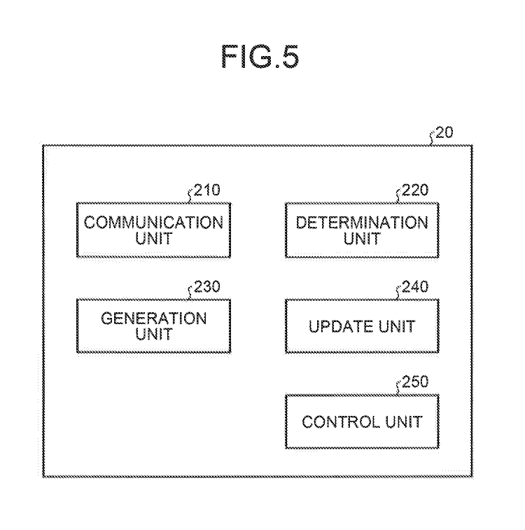

FIG. 4 is a block diagram illustrating an example of a hardware configuration of devices according to the embodiment. The coordinator 20 will be described as an example. As illustrated in FIG. 4, the coordinator 20 includes a central processing unit (CPU) 22, a random access memory (RAM) 23, a read only memory (ROM) 24, and a communication I/F 25. The hardware components are connected via a bus 21. The CPU 22 generally controls the operation of the coordinator 20. The CPU 22 controls the operation of the entire coordinator 20 by executing programs stored in the ROM 24 or the like using the RAM 23 as a work area. The communication I/F 25 is an interface used to communicate with external devices (such as the controllers 30 and the devices 40).

FIG. 5 is a block diagram illustrating an example of a functional configuration of the coordinator 20 according to the embodiment. As illustrated in FIG. 5, the coordinator 20 includes a communication unit 210, a determination unit 220, a generation unit 230, an update unit 240, and a control unit 250. The communication unit 210 controls various communications performed with the controller 30 and the device 40. The communication unit 210 also notifies about an updated synchronous counter as an update notification. The determination unit 220 determines whether or not a communication device forms an individual communication group. When it is determined that the communication device forms the individual communication group, the generation unit 230 uses a manipulation command including a digital signature of the coordinator 20 to generate a group key corresponding to the individual communication group. The update unit 240 updates a synchronous counter value of the synchronous counter. The control unit 250 controls a group manipulation of the controller 30 and the device 40 by using a group manipulation command message that includes an authentication code formed by the generated group key and the updated synchronous counter value. A part or all of each of the aforementioned units may be implemented by software (program) or by a hardware circuit. Each of the aforementioned units performs various processings to be described later.

Group Management

The security of ECHONET Lite can support four groups including a HAN group, an individual communication group, an application system group, and a controller group. Among these groups, the HAN group (the number of groups=1) can be used in performing the encrypted communication among all of the ECHONET Lite nodes within the domain. In the HAN group, a single group encryption key “K1” is shared among all the ECHONET Lite nodes in a domain.

The individual communication group can be used for encrypted communication between two specific ECHONET Lite nodes. When the two specific ECHONET Lite nodes have identifiers x and y, a group encryption key K_xy or a group encryption key K_yx (in the present embodiment, K_xy=K_yx) is shared between the node x and the node y.

The application system group (the number of groups=M) can be used in performing the encrypted communication between ECHONET Lite nodes (including the controller 30) connected to a specific controller 30. When the controller 30 has an identifier ‘ctl’, a group encryption key K_ctl is shared by the ECHONET Lite nodes connected to the controller ctl.

The controller group (the number of groups=1) can be used in performing the encrypted communication among all the controllers 30 within a domain. In the controller group, one group encryption key K2 is shared by all the controllers 30 within the domain.

In group communication conducted in any of the four groups described above, encrypted communication according to IEEE 802.21d is conducted. In the following, ‘+’ is an operator representing connection of character strings, and Type refers to a character for identifying a type that is any of a Leaf ID, an EUI 64 address, and a short address, which are ‘L’ (Leaf ID), ‘E’ (EUI 64 address), and ‘S’ (IEEE 802.15.4 short address). IDx and IDy are identifiers (any of a Leaf ID, an EUI 64 address, and an IEEE 802.15.4 short address) of two ECHONET Lite nodes belonging to an individual communication group, and IDctl is an identifier (any of a Leaf ID, an EUI 64 address, and an IEEE 802.15.4 short address) of the controller 30 in an application system.

In this case, a Leaf ID, an EUI 64 address, or an IEEE 802.15.4 short address may be used as IEEE 802.21 SourceIdentifier assigned to a packet. IEEE 802.21 SourceIdentifier assigned to a packet is “L10”, “E00112233AABBCCDD”, or “S0011”, for example. A Leaf ID is an identifier of a leaf node in a group management tree of IEEE 802.21d, and can be used as an IEEE 802.21d node. Note that the identifier of a leaf node in a group management tree is an example of an index. An index represents an identifier such as a MAC address, for example.

The length of a Leaf ID is dependent on the size of a group management tree. In a group management tree including 256 leaf nodes, the length of a Leaf ID in BASE 16 encoding is 2 bytes. The length of an EUI 64 address in BASE 16 encoding is 16 bytes, and the length of an IEEE 802.15.4 short address in BASE 16 encoding is 4 bytes. Hereinafter, it is assumed that BASE 16 encoding is used for encoding a Leaf ID, an EUI 64 address, and an IEEE 802.15.4 short address.

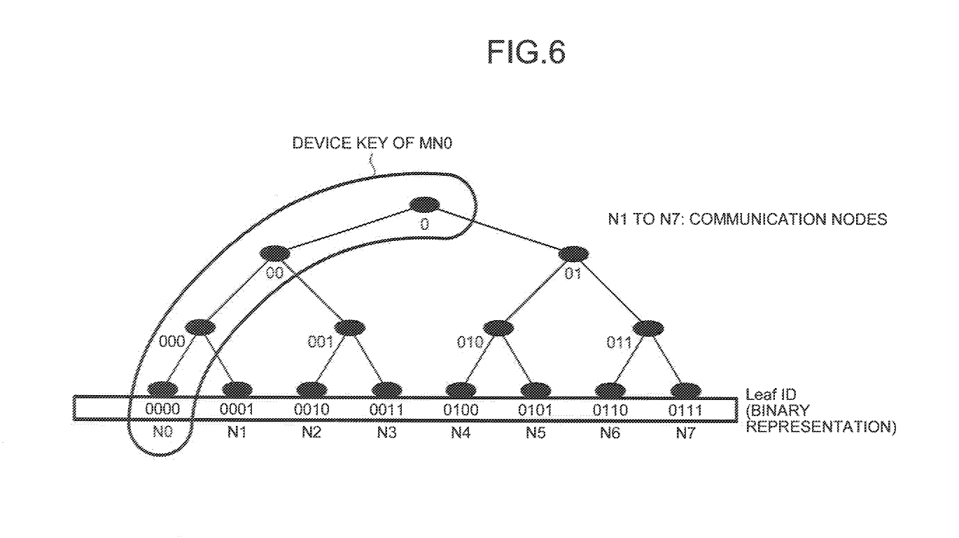

FIG. 6 is a diagram illustrating an example of the group management tree and Leaf IDs according to the embodiment. In FIG. 6, Leaf IDs are expressed by binary representations. In the group management tree, leaf nodes and communication nodes correspond one-to-one to each other. Furthermore, each of the nodes in the group management tree is associated with a unique 128-bit encryption key. Note that a list of encryption keys for a certain communication node, which are associated with nodes present on a path from a root node to a leaf node, is referred to as a device key for the communication node. For a node NO, for example, the nodes present on the path from the root node to the leaf node are a node 0, a node 00, a node 000, and a node 0000. The device key for a communication node is shared between the communication node and the GM. When members of a group include communication nodes N0, N1, N2, and N3, for example, the node key used for key encryption is the node key of the node 00. When members of a group include communication nodes N1, N2, N3, N4, N6, and N7, the node keys used for key encryption are the node keys of the node 00, a node 0100, and a node 011.

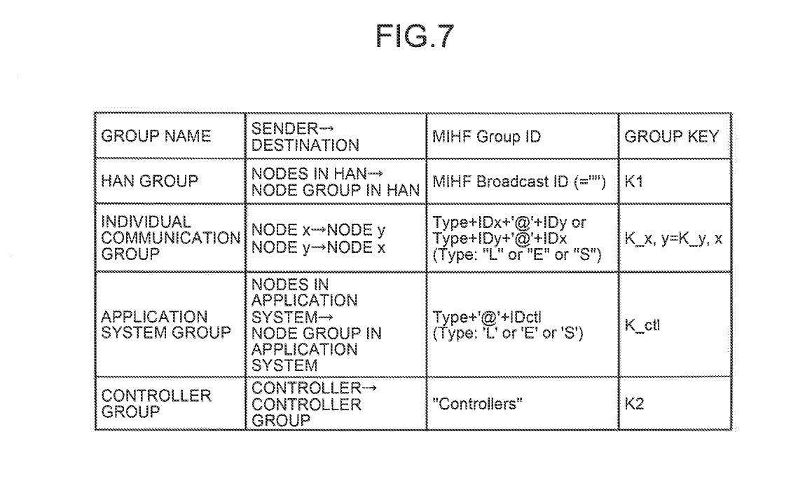

In the group communication, an MIHF Group ID defined according to IEEE 802.21d is used as an IEEE 802.21 DestinationIdentifier given to a packet. The value of the MIHF Group ID differs from group to group. FIG. 7 is a diagram illustrating an example of a group assignment rule according to the embodiment. For the HAN group, an MIHF Broadcast ID (=“ ”) is used as the MIHF Group ID. For an individual communication group, Type+IDx+‘@’+IDy is used as the MIHF Group ID. Examples of the MIHF Group IDs of individual communication groups include “L10@20”, “E00112233AABBCCDD@00112233BBCCDDEEFF”, and “S0011@AABB”.

For an application system group, Type+‘@’+IDctl is used as the MIHF Group ID. Examples of the MIHF Group IDs of application system groups include “L@20”, “E@00112233BBCCDDEEFF”, and “S@AABB”. For the controller group, “Controllers” is used as the MIHF Group ID. In the following, MIHF Group IDs other than the MIHF ID and the MIHF Broadcast may be expressed as “ID(Type)”. For example, an MIHF Group ID “10@20” is expressed as 10@20(L).

Communication Procedure

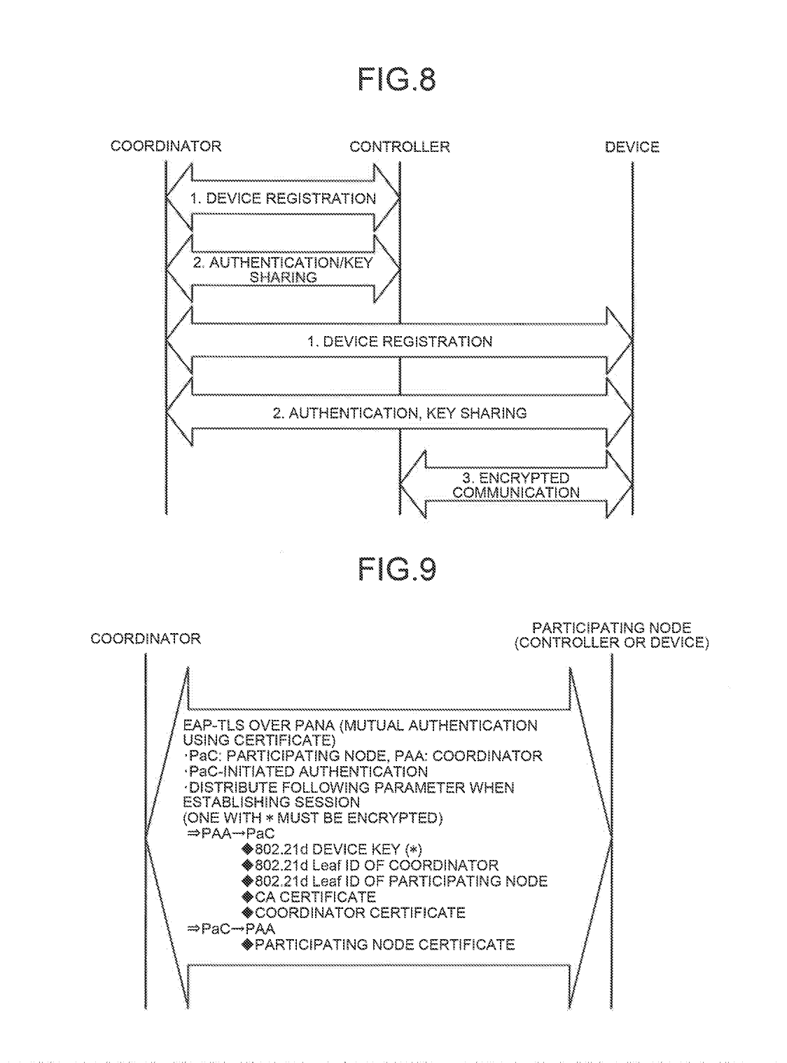

FIG. 8 is a diagram illustrating an overall sequence illustrating an example of communication procedures according to the embodiment. As illustrated in FIG. 8, “1. device registration” and “2. authentication/key sharing” are carried out between the coordinator 20 and a controller 30, and “3. encrypted communication” is carried out between a controller 30 and a device 40. Similarly, “1. device registration” and “2. authentication/key sharing” are carried out between the coordinator 20 and a device 40, and “3. encrypted communication” is carried out between a controller 30 and a device 40. Note that, in “1. device registration” and “2. authentication/key sharing,” the controller 30 and the device 40 can be started in any order. In the following, the controller 30 and the device 40 may be referred to as “participating nodes.”

First, device registration is carried out between the participating nodes and the coordinator 20. The participating nodes find the coordinator 20 by using UPnP, ECHONET Lite (both without security), or the like. Upon receiving a broadcast over UPnP, ECHONET Lite, or the like, the coordinator 20 registers the sender. Note that the registration may be determined when authentication/key sharing, which will be described later, is successful. If the authentication/key sharing results in a failure, the registration is discarded.

Subsequently, authentication and key sharing are carried out between the participating nodes and the coordinator 20. In the authentication between the participating nodes and the coordinator 20, certificates are exchanged for mutual authentication. When the authentication is successful, the coordinator 20 encrypts an 802.21d device key to be used for the key sharing and distributes the encrypted device key to the participating nodes. In order to reduce the processing load at reboot, the participating nodes are assumed to retain information distributed from the coordinator 20 during the authentication and the key sharing in a nonvolatile memory.

The key sharing between the participating nodes and the coordinator 20 is carried out through distribution of a group key from the coordinator 20 to the participating nodes. The group key may be distributed without any request from the participating nodes (push) or may be distributed upon request from the participating nodes (pull). Furthermore, the coordinator 20 may distribute, to a participating node, a certificate on another participating node.

Thereafter, encrypted communication is carried out between the participating nodes. In addition to encrypted communication between a controller 30 and a device 40, encrypted communication may also be carried out between controllers 30 and between devices 40. A message to be used for encrypted communication contains an encrypted ECHONET Lite telegraphic message, and can have a digital signature added thereto by a sender node. In the present embodiment, when a multicast is used for message transmission, for example, an All Nodes link local address (FF02:0:0:0:0:0:0:1) is used as the multicast address if the range of the domain matches with the range of an IP link.

FIG. 9 is a diagram illustrating an example of an authentication sequence according to the embodiment. In the authentication, mutual authentication using EAP-TLS defined by RFC 5216 using a certificate in PANA is carried out. In this process, X.509 certificate exchange and Elliptic curve Diffie-Hellman (ECDH) key exchange are carried out, and mutual authentication and a session key are established. An X.509 certificate from a certificate authority (CA) may also be distributed from the coordinator 20 to the participating nodes. If the authentication is successful, at least the 802.21d device keys of the participating nodes, the 802.21d Leaf ID of the coordinator 20, and the 802.21d Leaf IDs of the participating nodes are distributed from the coordinator 20 to the participating nodes. The 802.21d device keys of the participating nodes need to be encrypted before distribution. For the encryption in this process, an encryption function defined by RFC 6786 is used. Note that an established PANA session may be immediately deleted.

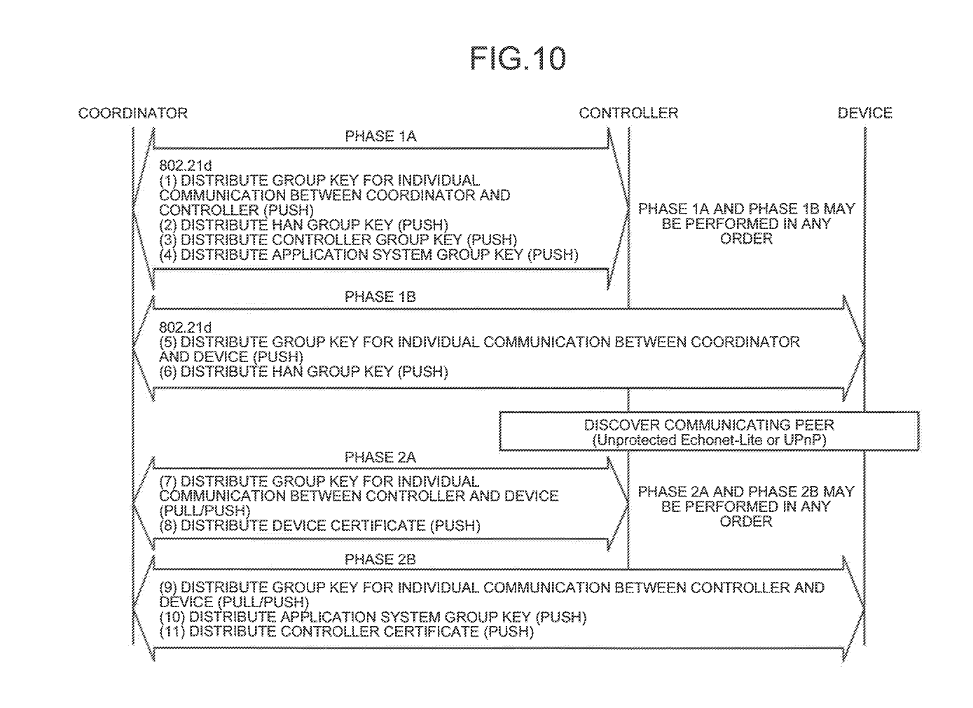

FIG. 10 is a diagram illustrating an example of a key sharing sequence according to the embodiment. The key sharing is divided into a phase (phase 1) carried out after completion of the authentication between the participating nodes and the coordinator 20 and a phase (phase 2) carried out when a participating node has found a communication peer with which to carry out encrypted communication. The phase 1 is divided into a phase 1A that is key sharing between the coordinator 20 and a controller 30 and a phase 1B that is key sharing between the coordinator 20 and a device 40. Note that either the phase 1A or the phase 1B may be carried out first. The phase 2 is divided into a phase 2A that is key sharing between the coordinator 20 and a controller 30 and a phase 2B that is key sharing between the coordinator 20 and a device 40. Note that either the phase 2A or the phase 2B may be carried out first. In each of the phase 1A, the phase 1B, the phase 2A, and the phase 2B, key sharing is carried out using IEEE 802.21d. The phases will be described below.

In the phase 1A, the coordinator 20 distributes an individual communication group key between the coordinator 20 and the controller 30 to the controller 30 through pushing (refer to step (1) in FIG. 10). The coordinator 20 then distributes a HAN group key to the controller 30 through pushing (refer to (step 2) in FIG. 10). The coordinator 20 then distributes a controller group key to the controller 30 through pushing (refer to step (3) in FIG. 10). Thereafter, the coordinator 20 distributes an application system group key to the controller 30 through pushing (refer to step (4) in FIG. 10).

In the phase 1B, the coordinator 20 distributes an individual communication group key between the coordinator 20 and the device 40 to the device 40 through pushing (refer to step (5) in FIG. 10). The coordinator 20 then distributes the HAN group key to the device 40 through pushing (refer to step (6) in FIG. 10).

In the phase 2A, the coordinator 20 distributes an individual communication group key between the controller 30 and the device 40 to the controller 30 through pulling or pushing (refer to step (7) in FIG. 10). Note that the distribution is carried out through pulling when the phase 2A is carried out prior to the phase 2B and that the distribution is carried out through pushing when the phase 2B is carried out prior to the phase 2A. The coordinator 20 then distributes an X.509 certificate of the device 40 to the controller 30 through pushing (refer to step (8) in FIG. 10).

In the phase 2B, the coordinator 20 distributes an individual communication group key between the controller 30 and the device 40 to the device 40 through pulling or pushing (refer to step (9) in FIG. 10). Note that the distribution is carried out through pulling when the phase 2A is carried out prior to the phase 2B and that the distribution is carried out through pushing when the phase 2B is carried out prior to the phase 2A. The coordinator 20 then distributes the application system group key to the device 40 through pushing (refer to step (10) in FIG. 10). Subsequently, the coordinator 20 distributes an X.509 certificate of the controller 30 to the device 40 through pushing (refer to step (11) in FIG. 10).

In the key sharing sequence illustrated in FIG. 10, the step (3) is unnecessary when no controller group key is used. The steps (4) and (10) are unnecessary when no application system group key is used. The step (8) is unnecessary when a sender signature of the device 40 is not attached in the encrypted communication. Moreover, the group key distribution through pushing can be replaced with group key distribution through pulling.

In the steps other than the steps (1) and (5), the IEEE 802.21d messages exchanged between the coordinator 20 and the participating nodes are transmitted to individual communication groups between the coordinator 20 and the participating nodes. The IEEE 802.21d messages exchanged in the steps (1) and (5) are transmitted to individual nodes. The steps (1) to (11) illustrated in FIG. 10 can be classified into three basic procedures of “group key distribution through pushing”, “group key distribution through pulling”, and “certificate distribution through pushing”. Hereinafter, the three procedures will be described.

In group key distribution through pushing, the coordinator 20 transmits an MIH_Net_Group_Manipulate request message to the participating nodes. A participating node in receipt of the MIH_Net_Group_Manipulate request message transmits an MIH_Net_Group Manipulate response message to the coordinator 20.

In group key distribution through pulling, a participating node transmits an MIH_MN_Group_Manipulate request message to the coordinator 20. The coordinator 20 in receipt of the MIH_MN_Group_Manipulate request message transmits an MIH_MN_Group_Manipulate response message to the participating node.

In certificate distribution through pushing, the coordinator 20 transmits an MIH_Push_Certificate request message to a participating node. The participating node in receipt of the MIH_Push_Certificate request message transmits an MIH_Push_Certificate response message to the coordinator 20.

Encrypted communication supports unicast encrypted communication and multicast encrypted communication. In unicast encrypted communication and multicast encrypted communication, MIH_Configuration_Update indication messages containing encrypted ECHONET Lite messages are used. The MIH_Configuration Update indication message in the unicast encrypted communication is transmitted to an individual communication group. The MIH_Configuration_Update indication message in the multicast encrypted communication is transmitted to groups other than the individual communication groups.

In certificate revocation, the coordinator 20 transmits an MIH_Revoke_Certificate request message in multicast or unicast. When the MIH_Revoke_Certificate request message is transmitted in multicast, the node (the controller 30 or the device 40) in receipt of the MIH_Revoke_Certificate request message within the domain transmits an MIH_Revoke_Certificate response message in unicast to the coordinator 20.

The unicast MIH_Revoke_Certificate request message in certificate revocation is transmitted to the group for individual communication between the coordinator 20 and the participating node. The multicast MIH_Revoke_Certificate request message is transmitted to the HAN group. The MIH_Revoke_Certificate response message is transmitted to the group for individual communication between the coordinator 20 and the participating node. Certificate revocation in unicast can be carried out in combination with certificate revocation in multicast.

For key update, the coordinator 20 starts group key distribution through pushing. In this process, an MIH_Net_Group_Manipulate request message is broadcast in multicast or transmitted in unicast to individual nodes. A participating node (the controller 30 or the device 40) in receipt of the MIH_Net_Group_Manipulate request message transmits an MIH_Net_Group Manipulate response message in unicast to the coordinator 20.

The unicast MIH_Net_Group_Manipulate request in key update message is transmitted to the group for individual communication between the coordinator 20 and the participating node. The multicast MIH_Net_Group Manipulate request message is transmitted to the HAN group. The MIH_Net_Group_Manipulate response message is transmitted to the group for individual communication between the coordinator 20 and the participating node. Key update in unicast can be carried out in combination with group key update in multicast.

The key update for a group is started when a member has left the group or when the group is deleted. Furthermore, it is preferable to avoid instantaneous interruption of communication due to key update, and the following implementation is recommended in packet transmission and packet reception. In packet transmission, an old key is used for a certain period (T) after reception of a new key by the coordinator 20, and the new key is used after the period (T). In packet reception, both of a new key and an old key can be used for a certain period (2T) after reception of the new key by the coordinator 20. Note that “T” is a maximum value of key update time, and a default value thereof is 180 seconds, for example.

A participating node that does not have a new key as a result of a failure in receiving the new key during key update may start group key distribution through pulling upon receiving a message encrypted with the new key to a group to which the node belongs. If the coordinator 20 has received no MIH_Net_Group_Manipulate response message from any of the nodes belonging to the group for the certain period 2T as a result of key update, the key update results in a failure. The coordinator 20 that has failed in key update may retry the key update, whereby a new key may be generated at each retrial of key update.

For deleting a group, key update specifying an empty Complete Subtree is carried out on the group to be deleted. Alternatively, key update using a Complete Subtree containing only one unused leaf node in a group management tree is carried out.

Security

Among common security processes applied to all the message in IEEE 802.21d used in the present embodiment, part that are not defined in detail by IEEE 802.21d will be defined. Security for protecting IEEE 802.21d messages include two types: secrecy and sender authentication. Of these types, the secrecy is achieved by using AES-CCM. The sender authentication is achieved by using ECDSA with a key length of 256 bits. When the secrecy is valid, a security association identifier (SAID), a type length value (TLV), and a security TLV are used. When the sender authentication is valid, a signature TLV is used. When both of the secrecy and the sender authentication are valid, a SAID TLV, a security TLV, and a signature TLV are used. Hereinafter, security policies on protection of IEEE 802.21d messages and a method for updating sequence numbers used in AES-CCM will be described.

The security policies include security policies for individual communication and security policies for group communication. In the present embodiment, individual communication refers to one-to-one communication using an MIHF ID for DestinationIdentifier of IEEE 802.21d. Group communication refers to multipoint-to-multipoint communication using an MIHF Group ID for DestinationIdentifier of IEEE 802.21d. Communication where the number of group members is two, which is a special case of group communication, is referred to as individual group communication. Individual communication and individual group communication are distinguished from each other in terms of security policies.

For individual communication, the secrecy is always valid and the sender authentication is always valid except for a predetermined message. The predetermined message is MIH_Capability_Discover request, for example. For group communication, security policies such as an overall policy, a policy for each sender, a policy for each message, and the like are set for each group. The overall policy is a security policy applied to the entire subject group. For the overall policy, a policy of either “valid” or “invalid” is set. The policy for each sender is a security policy applied to each of senders in the same group. For the policy for each sender, a sender to which an exception to the overall policy is applied is specified. For example, the policy for each sender is an exception=“invalid” when the overall policy is “valid”, and is an exception=“valid” when the overall policy is “invalid”. The policy for each sender is specified by a list of sender identifiers to which an exception to the overall policy is to be applied, a Bloom Filter, or a Complete Subtree.

The policy for each message is a policy applied to each of messages in the same group. For the policy for each message, a message to which an exception to the overall policy is applied is specified. For example, the policy for each message is an exception=“invalid” when the overall policy is “valid”, and is an exception=“valid” when the overall policy is “invalid”. The policy for each message is specified by a list of message identifiers to which an exception to the overall policy is to be applied, a Bloom Filter, or a bitmap.

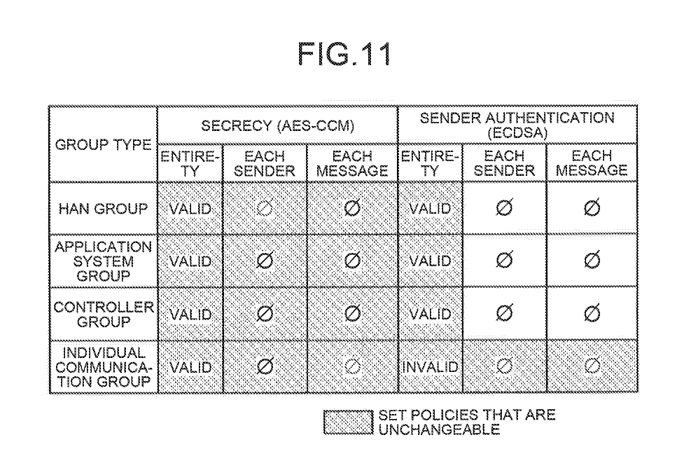

FIG. 11 is a table illustrating default values of group communication security policies according to the embodiment. In FIG. 11, hatched entries cannot be changed. Security policies that can be changed by setting are policies for each sender and policies for each message relating to sender authentication other than that for individual communication group. A security policy that can be changed is set by any of setting in advance, embedding policy information in a group identifier, and notification using a group manipulation command. Note that the group manipulation command is MIH_MN_Group_Manipulate or MIH_Net_Group_Manipulate.

For the AES-CCM of IEEE 802.21d, a 13-octet nonce is used. The nonce is a connection of TransactionID (2 octets), SequenceNumber (10 octets) and FragmentNumber (1 octet). Among these, TransactionID and FragmentNumber other than SequenceNumber are fields of a packet header.

In the present embodiment, SequenceNumber of the AES-CCM is managed for each sender and is not reset by the group generation or update of the group key. That is, it is assumed in the present embodiment that not all of the values of SequenceNumber will be used while a group exists. Note that existence of a group refers to that one or more nodes are included in the group.

SequenceNumber has a four-octet synchronous counter that increases monotonically and a six-octet subfield of a packet counter that increases monotonically. The synchronous counter is assigned by the coordinator 20 and notified to another node. The packet counter is incremented by one every time the IEEE 802.21 message is transmitted. Where the value of a current synchronous counter is “a” and the value of a current packet counter is “b”, for example, the value of SequenceNumber is expressed as (a, b).

SequenceNumber=(a, 0) is notified to each node by the key distribution through pushing or pulling when performing the authentication/key sharing and key update. The encrypted communication is cut off when the synchronization of SequenceNumber is lost by some reason such as reboot of a node, in which case the sequence number of resynchronized. Here, the synchronization loss of the sequence number occurs under the following condition. That is, the synchronization loss occurs when SequenceNumber is lost, when a difference between a value of SequenceNumber of a receiving frame and a value of the received SequenceNumber managed in the node exceeds a threshold, or when a certain period of time elapses after confirming that the synchronization of the sequence number is maintained, for example. The resynchronization of the sequence number is performed when the participating node acts as a trigger and when the coordinator 20 acts as a trigger.

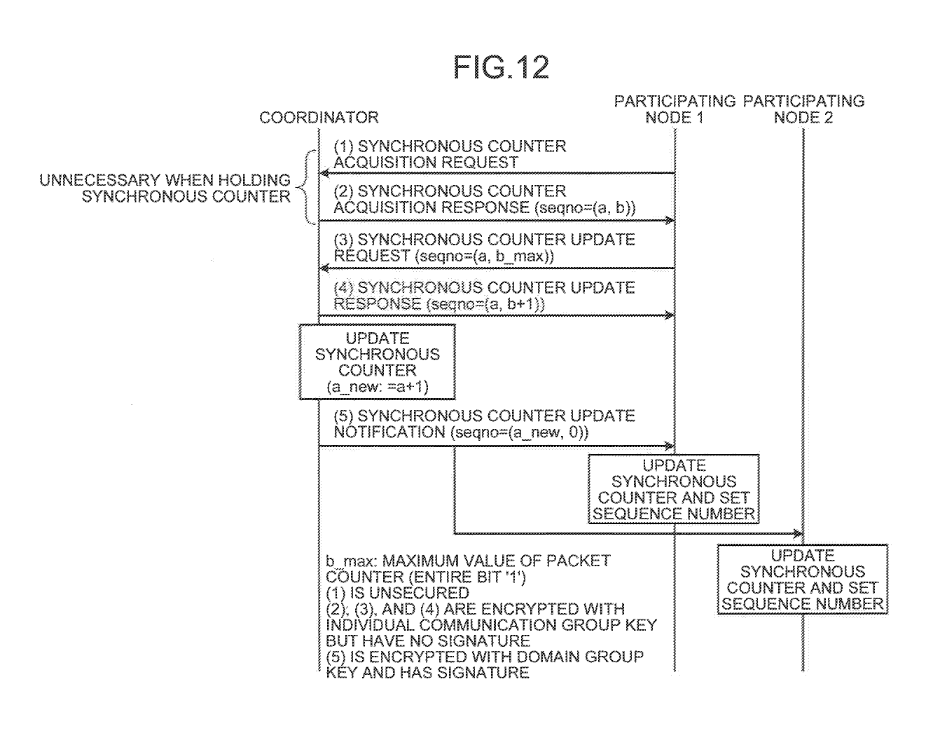

FIG. 12 is a diagram illustrating an example of the resynchronization of the sequence number according to the embodiment where the participating node acts as the trigger. Note that FIG. 12 illustrates an example where a participating node 1 and a participating node 2 are present as the participating nodes. As illustrated in (1) in FIG. 12, the participating node 1 makes a request to acquire the synchronous counter to the coordinator 20 when not holding the synchronous counter (such as “a”). The participating node 1 transmits, as the request to acquire the synchronous counter, an unsecured (unencrypted, without a signature) MIH_Capability_Discover request message to the coordinator 20, for example. The situation of not holding the synchronous counter can occur when rebooting or shifting from a sleep state to an active state in addition to a case when the participating node does not hold the synchronous counter from the start. The request to acquire the synchronous counter need not be made when the participating node 1 holds the synchronous counter, in which case a process in (3) in FIG. 12 is performed.

As illustrated in (2) in FIG. 12, the coordinator 20 that has received the request to acquire the synchronous counter transmits a response (synchronous counter acquisition response) to the request to acquire the synchronous counter to the participating node 1. The coordinator 20 transmits, as the response to the request to acquire the synchronous counter, an MIH_Capability_Discover response message that has been encrypted with an individual communication group key but has no signature to the participating node 1, for example. Upon receiving the synchronous counter acquisition response, the participating node 1 sets the synchronous counter thereof to the value of the synchronous counter (such as “a”) included in the sequence number of the receiving message.

As illustrated in (3) in FIG. 12, the participating node 1 that has received the synchronous counter acquisition response makes a request to update the synchronous counter to the coordinator 20. The participating node 1 transmits to the coordinator 20 an MIH_Registration request message that has been encrypted with an individual communication group key, has no signature, and has a request code=1, for example. The value of SequenceNumber of the MIH_Registration request message is set to (a, b_max) in this example. The value “b_max” is the maximum value of the packet counter.

As illustrated in (4) in FIG. 12, the coordinator 20 that has received the request to update the synchronous counter transmits a response (synchronous counter update response) to the request to update the synchronous counter to the participating node 1. The coordinator 20 transmits, as the response to the request to update the synchronous counter, an MIH_Registration response message that has been encrypted with an individual communication group key but has no signature to the participating node 1, for example. The participating node 1 performs next processing when successfully receiving the synchronous counter update response or, when failing to receive the synchronous counter update response, discards the synchronous counter being held and makes a request to acquire the synchronous counter.

Moreover, the coordinator 20 that has transmitted the synchronous counter update response increments the synchronous counter by one. Where the value of the synchronous counter after update is “a_new”, for example, the coordinator 20 updates the value to a_new=a+1. Then, as illustrated in (5) in FIG. 12, the coordinator 20 upon updating the synchronous counter notifies the participating nodes 1 and 2 of a synchronous counter update notification having SequenceNumber (a_new, 0) by multicasting addressed to the HAN group. The synchronous counter update notification is an MIH_Configuration Update indication message that is encrypted with a domain group key with null ConfigurationData and has a signature, for example.

Accordingly, each participating node that has received the synchronous counter update notification updates the value of the synchronous counter as well as sets all SequenceNumber for transmission and reception managed therein to (a_new, 0). The participating node that has failed to resynchronize SequenceNumber for reception deletes a state relevant to all groups and executes the key sharing sequence described above. Note that a message authentication code according to the individual communication group key may be given not only to the group manipulation command message but to another message. The code may be used when distributing the device certificate or controller certificate in the steps (8) and (11) illustrated in FIG. 10, for example. Moreover, the synchronous counter may be updated when the message for individual communication group manipulation command is not included or when a group key corresponding to the individual communication group is not used.

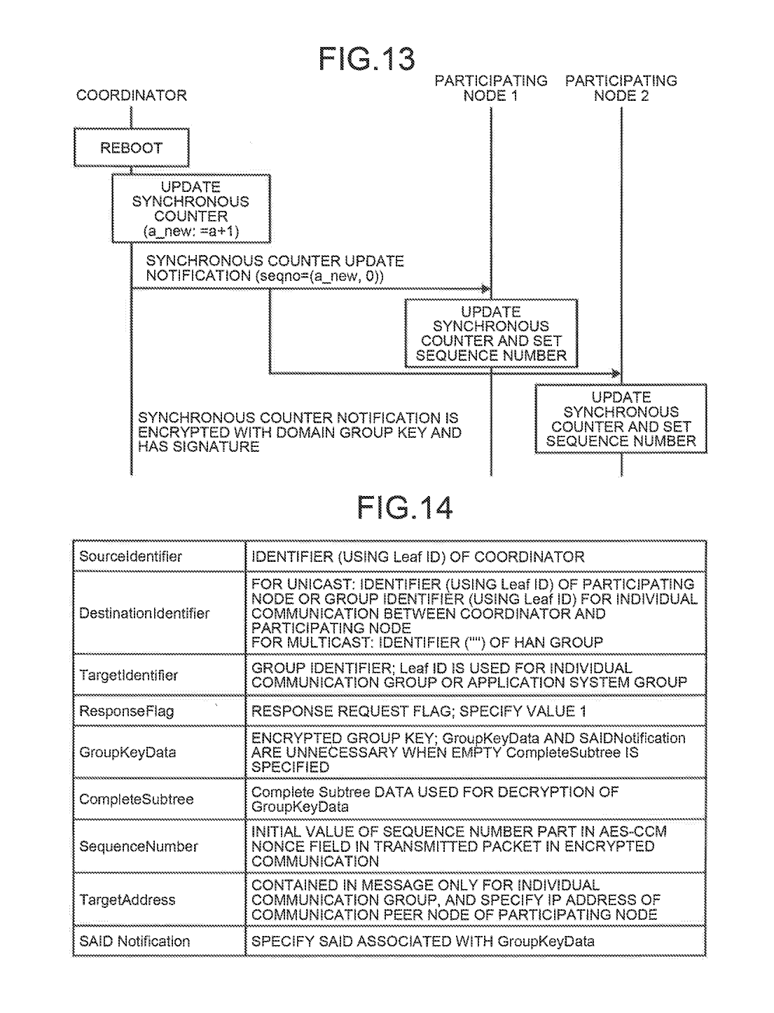

FIG. 13 is a diagram illustrating an example of the resynchronization of the sequence number according to the embodiment where the coordinator 20 acts as the trigger. FIG. 13 illustrates an example where the participating node 1 and the participating node 2 are present as the participating nodes. As illustrated in FIG. 13, the coordinator 20 increments the synchronous counter by one after reboot. The coordinator 20 updates the synchronous counter value to a_new=a+1 as described above. Then, the coordinator 20 notifies the participating nodes 1 and 2 of the synchronous counter update notification having SequenceNumber (a_new, 0) by multicasting addressed to the HAN group. The synchronous counter update notification is the MIH_Configuration_Update indication message that has been encrypted with the domain group key with the null ConfigurationData and has the signature, as described above. Accordingly, each participating node that has received the synchronous counter update notification updates the value of the synchronous counter as well as sets all SequenceNumber for transmission and reception managed therein to (a_new, 0).

IEEE 802.21d Message TLV

Security-policy-independent TLVs contained in IEEE 802.21d messages used in the present embodiment will be described. The security-policy-independent TLVs are IEEE 802.21d TLVs other than SAID TLVs, Security TLVs, and Signature TLVs.

FIG. 14 is a diagram illustrating examples of the security-policy-independent TLVs included in the MIH_Net_Group_Manipulate request messages according to the embodiment. As illustrated in FIG. 14, SourceIdentifier is an identifier of the coordinator 20. For unicast, DestinationIdentifier is an identifier of a participating node or an identifier of a group for individual communication between the coordinator 20 and a participating node. For multicast, DestinationIdentifier is an identifier of the HAN group. TargetIdentifier is a group identifier and a Leaf ID is used for an individual communication group or an application system group.

ResponseFlag is a response request flag, and specifies a value “1”. GroupKeyData is an encrypted group key, and GroupKeyData and SAIDNotification are unnecessary when empty CompleteSubtree is specified. CompleteSubtree is CompleteSubtree data used for decryption of GroupKeyData. SequenceNumber is an initial value of a SequenceNumber part in an AES-CCM nonce field in a transmitted packet in encrypted communication. TargetAddress is contained in a message for an individual communication group, and specifies an IP address of a communication peer node of a participating node. SAID Notification specifies SAID associated with GroupKeyData.

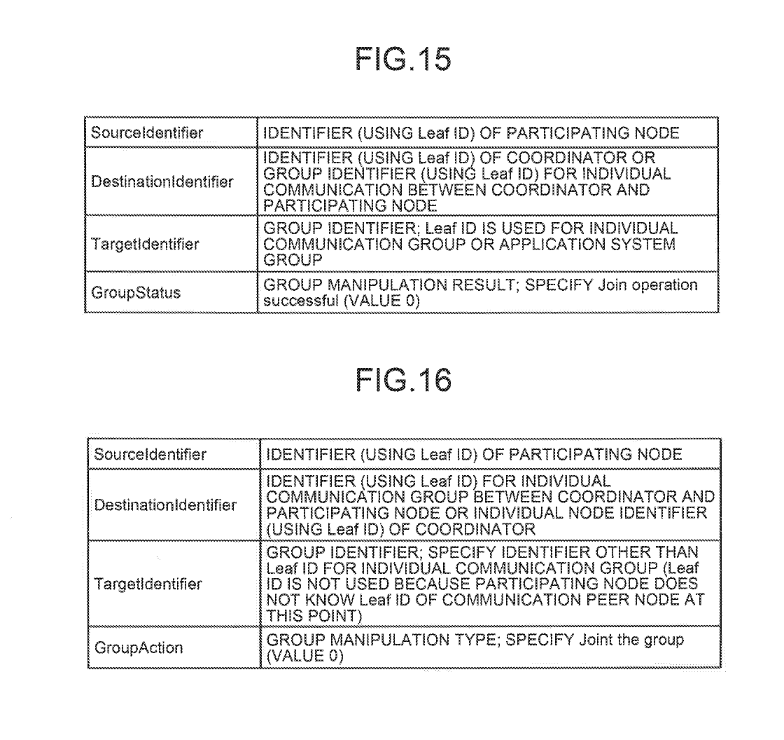

FIG. 15 is a table illustrating examples of the security-policy-independent TLVs contained in MIH_Net_Group_Manipulate response messages according to the embodiment. As illustrated in FIG. 15, SourceIdentifier is an identifier of a participating node. DestinationIdentifier is an identifier of the coordinator 20, or a group identifier for individual communication between the coordinator 20 and a participating node. TargetIdentifier is a group identifier and a Leaf ID is used for an individual communication group or an application system group. GroupStatus is a group manipulation result, and specifies Join operation successful (value “0”).

FIG. 16 is a table illustrating examples of the security-policy-independent TLVs included in the MIH_MN_Group_Manipulate request messages according to the embodiment. As illustrated in FIG. 16, SourceIdentifier is an identifier of the participating node. DestinationIdentifier is an identifier of the individual communication group between the coordinator 20 and the participating node or an individual node identifier of the coordinator 20. TargetIdentifier is a group identifier and specifies an identifier other than the Leaf ID for an individual communication group. GroupAction is a group manipulation type and specifies “Join the group” (value “O”).

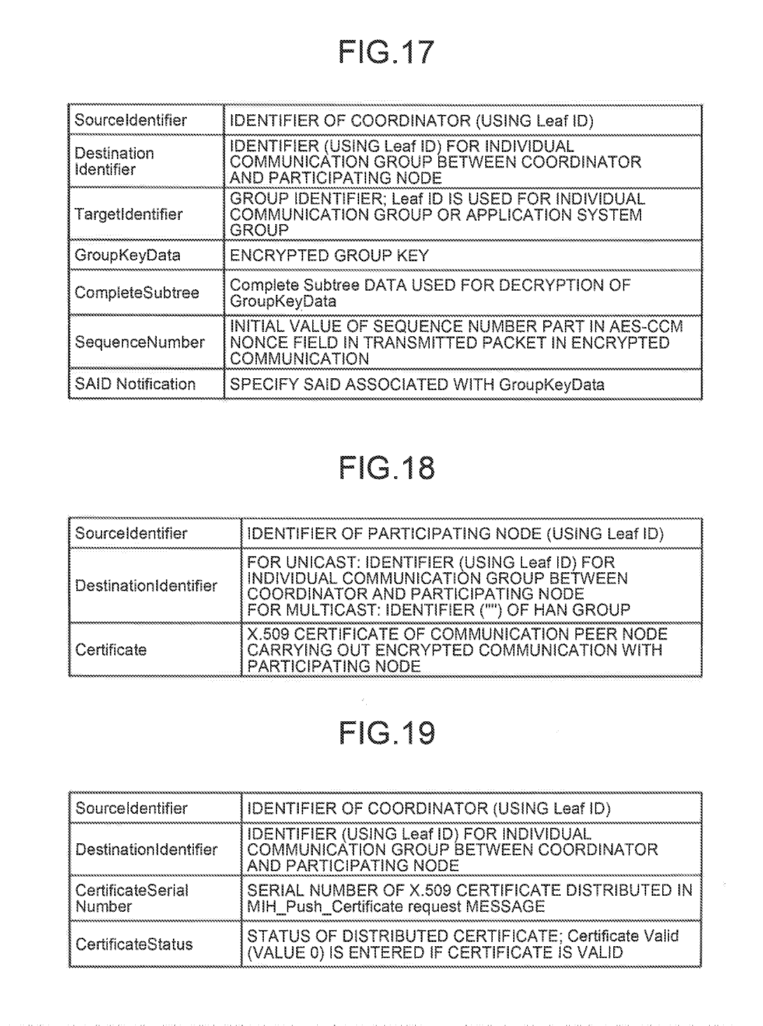

FIG. 17 is a table illustrating examples of the security-policy-independent TLVs included in MIH_MN Group_Manipulate response messages according to the embodiment. As illustrated in FIG. 17, SourceIdentifier is an identifier of the coordinator 20. DestinationIdentifier is an identifier of the individual communication group between the coordinator 20 and a participating node or an individual node identifier of the participating node. TargetIdentifier is a group identifier, and a Leaf ID is used for an individual communication group or an application system group. GroupKeyData is an encrypted group key. CompleteSubtree is CompleteSubtree data used for decryption of GroupKeyData. SequenceNumber is an initial value of a SequenceNumber part in the AES-CCM nonce field in a transmitted packet in encrypted communication. SAID Notification specifies SAID associated with GroupKeyData.

FIG. 18 is a table illustrating examples of the security-policy-independent TLVs included in MIH_Push_Certificate request messages according to the embodiment. As illustrated in FIG. 18, SourceIdentifier is an identifier of a participating node. For unicast, DestinationIdentifier is an identifier of the individual communication group between the coordinator 20 and a participating node. For multicast, DestinationIdentifier is an identifier of the HAN group. Certificate is an X.509 certificate of a communicating peer node that performs encrypted communication with a participating node.

FIG. 19 is a table illustrating examples of the security-policy-independent TLVs included in MIH_Push_Certificate response messages according to the embodiment. As illustrated in FIG. 19, SourceIdentifier is an identifier of the coordinator 20. DestinationIdentifier is an identifier of an individual communication group between the coordinator 20 and a participating node. CertificateSerialNumber is a serial number of an X.509 certificate distributed in an MIH_Push_Certificate request message. CertificateStatus is a status of a distributed certificate, and Certificate Valid (value “0”) is entered when the certificate is valid.

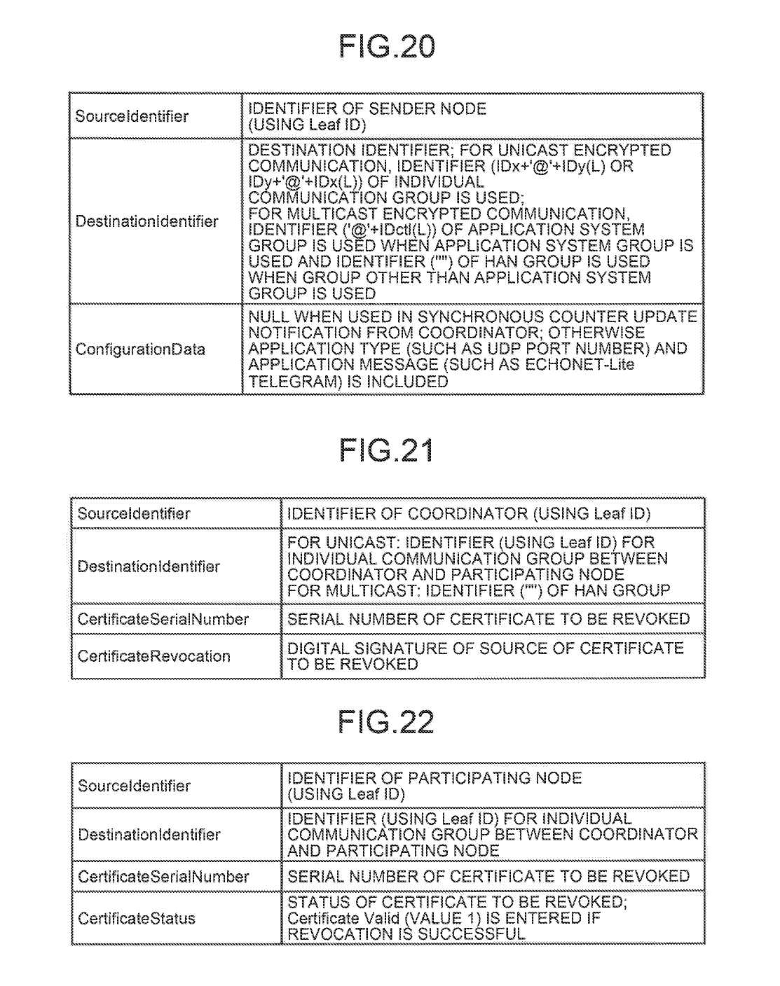

FIG. 20 is a table illustrating examples of the security-policy-independent TLVs included in MIH_Configuration_Update indication messages according to the embodiment. As illustrated in FIG. 20, SourceIdentifier is an identifier of a sender node. DestinationIdentifier is a destination identifier, and an identifier of an individual communication group is used for unicast encrypted communication. Here, the identifier of an individual communication group is IDx+‘@’+IDy(L) or IDy+‘@’+IDx(L). For multicast encrypted communication, DestinationIdentifier is an identifier (‘@’+IDctl(L)) of an application system group when an application system group is used or an identifier (“ ”) of the HAN group when a group other than the application system group is used. ConfigurationData is null when used in the synchronous counter update notification from the coordinator 20 or otherwise includes an application type (UDP port number) and an application message (ECHONET-Lite telegram).

FIG. 21 is a table illustrating examples of the security-policy-independent TLVs included in MIH_Revoke_Certificate request messages according to the embodiment. As illustrated in FIG. 21, SourceIdentifier is an identifier of the coordinator 20. For unicast, DestinationIdentifier is an identifier of the individual communication group between the coordinator 20 and a participating node. For multicast, DestinationIdentifier is an identifier of the HAN group. CertificateSerialNumber is a serial number of a certificate to be revoked. CertificateRevocation is a digital signature of a source of a certificate to be revoked.

FIG. 22 is a table illustrating examples of the security-policy-independent TLVs included in MIH_Revoke_Certificate response messages according to the embodiment. As illustrated in FIG. 22, SourceIdentifier is an identifier of a participating node. DestinationIdentifier is an identifier of the individual communication group between the coordinator 20 and a participating node. CertificateSerialNumber is a serial number of a certificate to be revoked. CertificateStatus is a status of a certificate to be revoked and Certificate Valid (value “1”) is set when the revocation is successful.

Next, detailed sequences of key sharing, encrypted communication, certificate revocation, and key update according to the present embodiment will be described.

Detailed Sequence of Key Sharing Phase 1

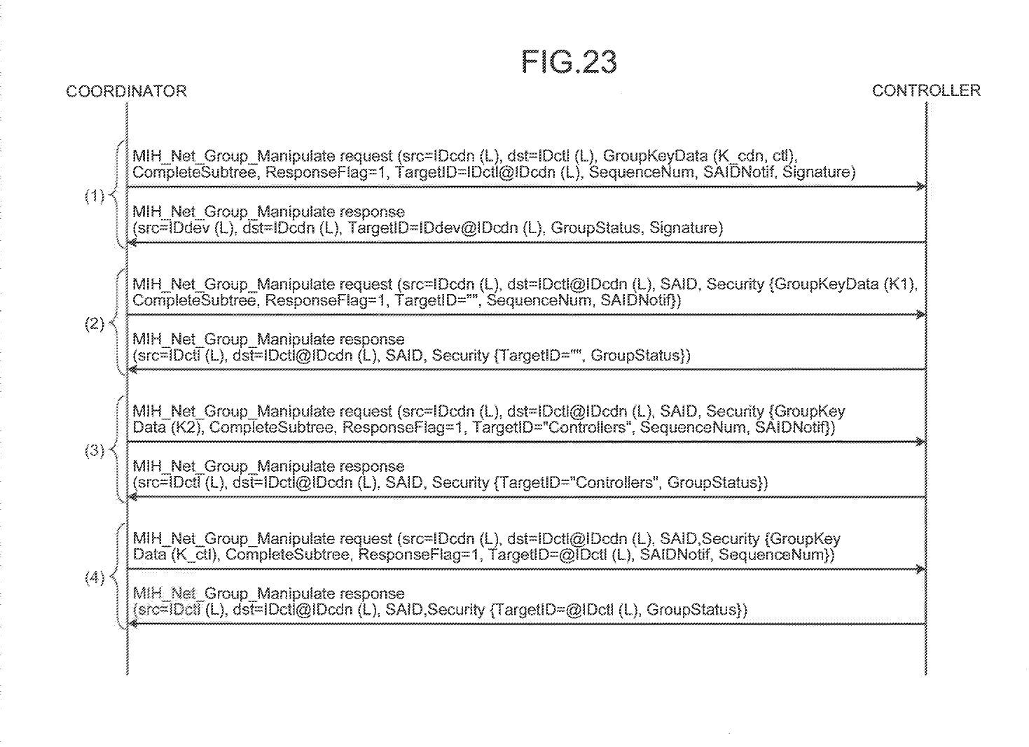

FIG. 23 is an example of a detailed sequence of the key sharing phase 1A according to the embodiment. As illustrated in FIG. 23, IDctl indicates an identifier of the controller 30, IDcdn indicates the identifier of the coordinator 20, and IDdev indicates an identifier of the device 40. Moreover, steps (1) to (4) illustrated in FIG. 23 correspond to the steps (1) to (4) illustrated in FIG. 10.

As illustrated in step (1) in FIG. 23, the coordinator 20 transmits an MIH_Net_Group_Manipulate request message to the controller 30. The MIH_Net_Group Manipulate request message includes “src=IDcdn(L), dst=IDctl(L), GroupKeyData(K_cdn, ctl), CompleteSubtree, ResponseFlag=1, TargetID=IDctl@IDcdn(L), SequenceNum, SAIDNotif, Signature”. The controller 30 in receipt of the MIH_Net_Group_Manipulate request message transmits an MIH_Net_Group_Manipulate response message to the coordinator 20. The MIH_Net_Group Manipulate response message includes “src=IDdev(L), dst=IDcdn(L), TargetID=IDdev@IDcdn(L), GroupStatus, Signature”.

As illustrated in step (2) in FIG. 23, the coordinator 20 transmits an MIH_Net_Group Manipulate request message to the controller 30. The MIH_Net_Group Manipulate request message includes “src=IDcdn(L), dst=IDctl@IDcdn(L), SAID, Security{GroupKeyData(K1), CompleteSubtree, ResponseFlag=1, TargetID=“ ”, SequenceNum, SAIDNotif}”. The controller 30 in receipt of the MIH_Net_Group Manipulate request message transmits an MIH_Net_Group_Manipulate response message. The MIH_Net_Group_Manipulate response message includes “src=IDctl(L), dst=IDctl@IDcdn(L), SAID, Security{TargetID=“ ”, GroupStatus}”.

As illustrated in step (3) in FIG. 23, the coordinator 20 transmits an MIH_Net_Group_Manipulate request message to the controller 30. The MIH_Net_Group_Manipulate request message includes “src=IDcdn(L), dst=IDctl@IDcdn(L), SAID, Security{GroupKeyData(K2), CompleteSubtree, ResponseFlag=1, TargetID=“Controllers”, SequenceNum, SAIDNotif}”. The controller 60 in receipt of the MIH_Net_Group Manipulate request message transmits an MIH_Net_Group_Manipulate response message to the coordinator 20. The MIH_Net_Group_Manipulate response message includes “src=IDctl(L), dst=IDctl@IDcdn(L), SAID, Security{TargetID=“Controllers”, GroupStatus}”.

As illustrated in step (4) in FIG. 23, the coordinator 20 transmits an MIH_Net_Group_Manipulate request message to the controller 30. The MIH_Net_Group Manipulate request message includes “src=IDcdn(L), dst=IDctl@IDcdn(L), SAID, Security{GroupKeyData(K_ctl), CompleteSubtree, ResponseFlag=1, TargetID=@IDctl(L), SAIDNotif, SequenceNum}”. The controller 30 in receipt of the MIH_Net_Group_Manipulate request message transmits an MIH_Net_Group_Manipulate response message to the coordinator 20. The MIH_Net_Group_Manipulate response message includes “src=IDctl(L), dst=IDctl@IDcdn(L), SAID, Security{TargetID=@IDctl(L), GroupStatus}”.

In the key sharing phase 1A, MIH registration defined in IEEE 802.21-2008 may be performed to the coordinator 20 by the controller 30 prior to performing step (1) in FIG. 23.

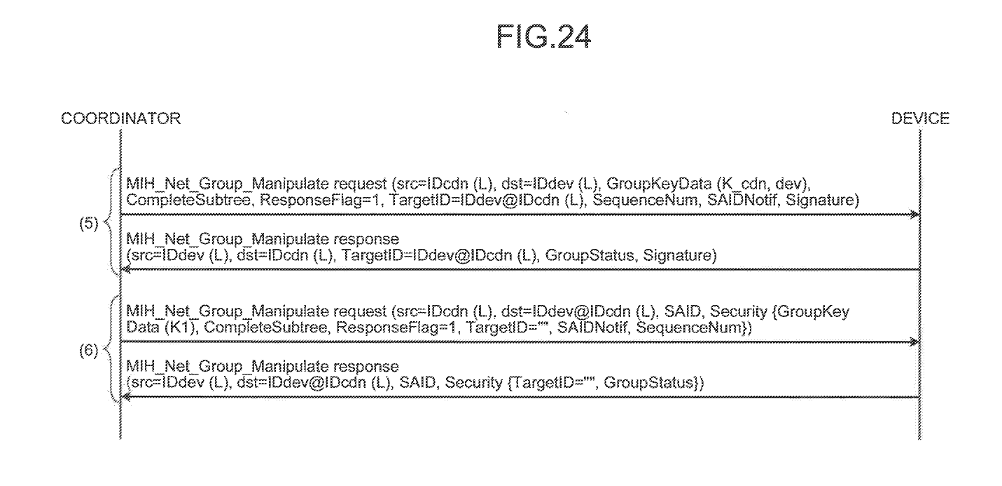

FIG. 24 is an example of a detailed sequence of the key sharing phase 1B according to the embodiment. As illustrated in FIG. 24, IDctl indicates the identifier of the controller 30, IDcdn indicates the identifier of the coordinator 20, and “IDdev” indicates the identifier of the device 40. Moreover, steps (5) and (6) illustrated in FIG. 24 correspond to the steps (5) and (6) illustrated in FIG. 10.

As illustrated in step (5) in FIG. 24, the coordinator 20 transmits an MIH_Net_Group_Manipulate request message to the device 40. The MIH_Net_Group_Manipulate request message includes “src=IDcdn(L), dst=IDdev(L), GroupKeyData(K_cdn,dev), CompleteSubtree, ResponseFlag=1, TargetID=IDdev@IDcdn(L), SequenceNum, SAIDNotif, Signature”. The device 40 in receipt of the MIH_Net_Group Manipulate request message transmits an MIH_Net_Group_Manipulate response message to the coordinator 20. The MIH_Net_Group Manipulate response message includes “src=IDdev(L), dst=IDcdn(L), TargetID=IDdev@IDcdn(L), GroupStatus, Signature”.

As illustrated in step (6) in FIG. 24, the coordinator 20 transmits an MIH_Net_Group_Manipulate request message to the device 40. The MIH_Net_Group_Manipulate request message includes “src=IDcdn(L), dst=IDdev@IDcdn(L), SAID, Security{GroupKeyData(K1), CompleteSubtree, ResponseFlag=1, TargetID=“ ”, SAIDNotif, SequenceNum}”. The device 40 in receipt of the MIH_Net_Group Manipulate request message transmits an MIH_Net_Group Manipulate response message to the coordinator 20. The MIH_Net_Group_Manipulate response message includes “src=IDdev(L), dst=IDdev@IDcdn(L), SAID, Security{TargetID=“ ”, GroupStatus}”.

In the key sharing phase 1B, MIH registration defined in IEEE 802.21-2008 may be performed to the coordinator 20 by the device 40 prior to performing step (5) in FIG. 24.

Detailed Sequence of Key Sharing Phase 2

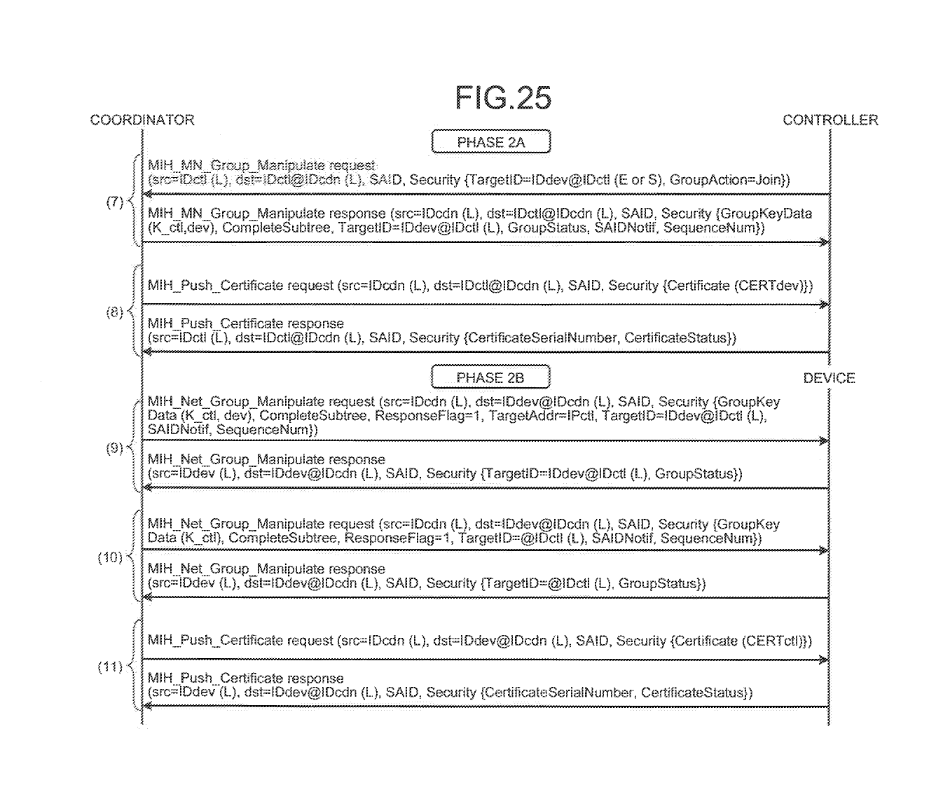

FIG. 25 is an example of a detailed sequence of the key sharing phase 2 according to the embodiment. FIG. 25 illustrates an example in which the phase 2A is performed prior to the phase 2B. As illustrated in FIG. 25, IDctl indicates the identifier of the controller 30, IDcdn indicates the identifier of the coordinator 20, and IDdev indicates the identifier of the device 40. Moreover, steps (7) to (11) illustrated in FIG. 25 correspond to the steps (7) to (11) illustrated in FIG. 10.

As illustrated in step (7) in FIG. 25, the controller 30 transmits an MIH_MN_Group_Manipulate request message to the coordinator 20. The MIH_MN_Group_Manipulate request message includes “src=IDctl(L), dst=IDctl@IDcdn(L), SAID, Security{TargetID=IDdev@IDctl(E or S), GroupAction=join}”. The coordinator 20 in receipt of the MIH_MN_Group_Manipulate request message transmits an MIH_MN_Group_Manipulate response message to the controller 30. The MIH_MN_Group_Manipulate response message includes “src=IDcdn(L), dst=IDctl@IDcdn(L), SAID, Security{GroupKeyData (K_ctl,dev), CompleteSubtree, TargetID=IDdev@IDctl(L), GroupStatus, SAIDNotif, SequenceNum}”.

As illustrated in step (8) in FIG. 25, the coordinator 20 transmits an MIH_Push_Certificate request message to the controller 30. The MIH_Push_Certificate request message includes “src=IDcdn(L), dst=IDctl@IDcdn(L), SAID, Security{Certificate(CERTdev)}”. The controller 30 in receipt of the MIH_Push_Certificate request message transmits an MIH_Push_Certificate response message to the coordinator 20. The MIH_Push_Certificate response message includes “src=IDctl(L), dst=IDctl@IDcdn(L), SAID, Security{CertificateSerialNumber, CertificateStatus}”.

As illustrated in step (9) in FIG. 25, the coordinator 20 transmits an MIH_Net_Group_Manipulate request message to the device 40. The MIH_Net_Group_Manipulate request message includes “src=IDcdn(L), dst=IDdev@IDcdn(L), SAID, Security{GroupKeyData(K_ctl,dev), CompleteSubtree, ResponseFlag=1, TargetAddr=IDctl, TargetID=IDdev@IDctl(L), SAIDNotif, SequenceNum}”. The device 40 in receipt of the MIH_Net_Group_Manipulate request message transmits an MIH_Net_Group_Manipulate response message to the coordinator 20. The MIH_Net_Group Manipulate response message includes “src=IDdev(L), dst=IDdev@IDcdn(L), SAID, Security{TargetID=IDdev@IDctl(L), GroupStatus}”.

As illustrated in step (10) in FIG. 25, the coordinator 20 transmits an MIH_Net_Group Manipulate request message to the device 40. The MIH_Net_Group Manipulate request message includes “src=IDcdn(L), dst=IDdev@IDcdn(L), SAID, Security{GroupKeyData (K_ctl), CompleteSubtree, ResponseFlag=1, TargetID=IDctl(L), SAIDNotif, SequenceNum}”. The device 40 in receipt of the MIH_Net_Group_Manipulate request message transmits an MIH_Net_Group_Manipulate response message to the coordinator 20. The MIH_Net_Group_Manipulate response message includes “src=IDdev(L), dst=IDdev@IDcdn(L), SAID, Security{TargetID=@IDctl(L), GroupStatus}”.

As illustrated in step (11) in FIG. 25, the coordinator 20 transmits an MIH_Push_Certificate request message to the device 40. The MIH_Push_Certificate request message includes “src=IDcdn(L), dst=IDdev@IDcdn(L), SAID, Security{Certificate (CERTctl)}”. The device 40 in receipt of the MIH_Push_Certificate request message transmits an MIH_Push_Certificate response message to the coordinator 20.

The MIH_Push_Certificate response message includes “src=IDdev(L), dst=IDdev@IDcdn(L), SAID, Security{CertificateSerialNumber, CertificateStatus}”.

When the key sharing phase 2B is used for key sharing for communication performed between the controllers 30, the device 40 (IDdev) in the key sharing phase 2B is replaced by a controller 30 (IDctl′) with which the controller 30 (IDctl) in the key sharing phase 2A communicates and step (7) is omitted. Alternatively, when the key sharing phase 2A is used for key sharing for communication performed between devices 40, the controller 30 (IDctl) in the key sharing phase 2A is replaced by a device 40 (IDdev′) with which the device 40 (IDdev) in the key sharing phase 2B communicates and step (7) is omitted.

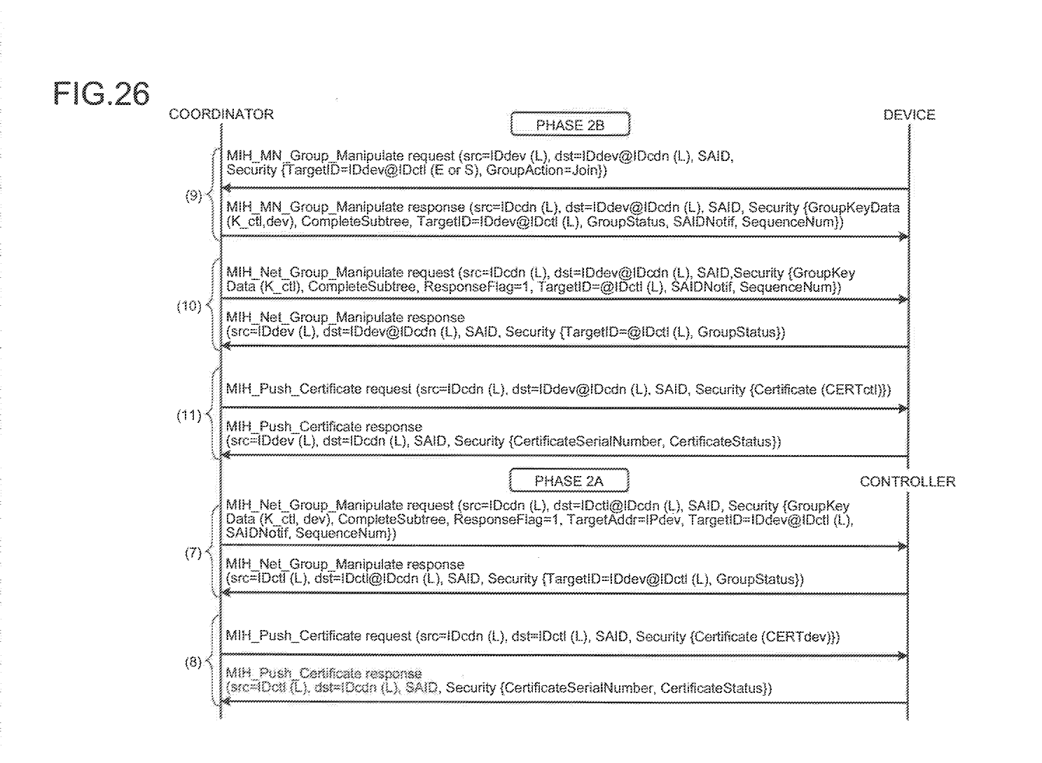

FIG. 26 is an example of a detailed sequence of the key sharing phase 2 according to the embodiment. FIG. 26 illustrates an example in which the phase 2B is performed prior to the phase 2A. As illustrated in FIG. 26, IDctl indicates the identifier of the controller 30, IDcdn indicates the identifier of the coordinator 20, and IDdev indicates the identifier of the device 40. Moreover, steps (7) to (11) illustrated in FIG. 26 correspond to the steps (7) to (11) illustrated in FIG. 10.

As illustrated in step (9) in FIG. 26, the device 40 transmits an MIH_MN_Group_Manipulate request message to the coordinator 20. The MIH_MN_Group_Manipulate request message includes “src=IDdev(L), dst=IDdev@IDcdn(L), SAID, Security {TargetID=IDdev@IDctl(E or S), GroupAction=join}”. The coordinator 20 in receipt of the MIH_MN_Group_Manipulate request message transmits an MIH_MN_Group_Manipulate response message to the device 40. The MIH_MN_Group_Manipulate response message includes “src=IDcdn(L), dst=IDdev@IDcdn(L), SAID, Security{GroupKeyData(K_ctl,dev), CompleteSubtree, TargetID=IDdev@IDctl(L), GroupStatus, SAIDNotif, SequenceNum}”.

As illustrated in step (10) in FIG. 26, the coordinator 20 transmits an MIH_Net_Group_Manipulate request message to the device 40. The MIH_Net_Group_Manipulate request message includes “src=IDcdn(L), dst=IDdev@IDcdn(L), SAID, Security{GroupKeyData(K_ctl), CompleteSubtree, ResponseFlag=1, TargetID=@IDctl(L), SAIDNotif, SequenceNum}”. The device 40 in receipt of the MIH_Net_Group_Manipulate request message transmits an MIH_Net_Group_Manipulate response message to the coordinator 20. The MIH_Net_Group_Manipulate response message includes “src=IDdev(L), dst=IDdev@IDcdn(L), SAID, Security{TargetID=@IDctl(L), GroupStatus}”.

As illustrated in step (11) in FIG. 26, the coordinator 20 transmits an MIH_Push_Certificate request message to the device 40. The MIH_Push_Certificate request message includes “src=IDcdn(L), dst=IDdev@IDcdn(L), SAID, Security{Certificate(CERTctl)}”. The device 40 in receipt of the MIH_Push_Certificate request message transmits an MIH_Push_Certificate response message to the coordinator 20. The MIH_Push_Certificate response message includes “src=IDdev(L), dst=IDcdn(L), SAID, Security{CertificateSerialNumber, CertificateStatus}”.

As illustrated in step (7) in FIG. 26, the coordinator 20 transmits an MIH_Net_Group_Manipulate request message to the controller 30. The MIH_Net_Group_Manipulate request message includes “src=IDcdn(L), dst=IDctl@IDcdn(L), SAID, Security{GroupKeyData(K_ctl,dev), CompleteSubtree, ResponseFlag=1, TargetAddr=IPdev, TargetID=IDdev@IDctl (L), SAIDNotif, SequenceNum}”. The controller 30 in receipt of the MIH_Net_Group Manipulate request message transmits an MIH_Net_Group_Manipulate response message to the coordinator 20. The MIH_Net_Group_Manipulate response message includes “src=IDctl(L), dst=IDctl@cdn(L), SAID, Security{TargetID=IDdev@IDctl(L), GroupStatus}”.

As illustrated in step (8) in FIG. 26, the coordinator 20 transmits an MIH_Push_Certificate request message to the controller 30. The MIH_Push_Certificate request message includes “src=IDcdn(L), dst=IDctl(L), SAID, Security{Certificate(CERTdev)}”. The controller 30 in receipt of the MIH_Push_Certificate request message transmits an MIH_Push_Certificate response message to the coordinator 20. The MIH_Push_Certificate response message includes “src=IDctl (L), dst=IDcdn(L), SAID, Security{CertificateSerialNumber, CertificateStatus}”.

Detailed Sequence of Encrypted Communication

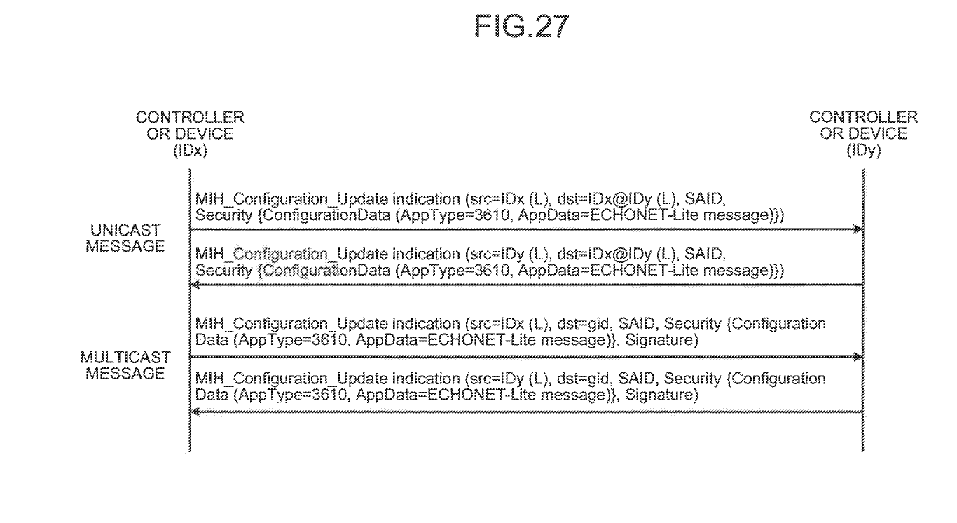

FIG. 27 is an example of a detailed sequence of encrypted communication according to the embodiment. In FIG. 27, gid indicates the group identifier, and gid=@IDctl(L) is set for the application system group while gid=“ ” is set for a group other than the application system group. As illustrated in FIG. 27, a controller 30 or a device 40 both through unicast encrypted communication and multicast encrypted communication. The transmission and reception of the MIH_Configuration_Update indication message are performed by a controller 30 or a device 40 (IDx) and a controller 30 or a device 40 (IDy).

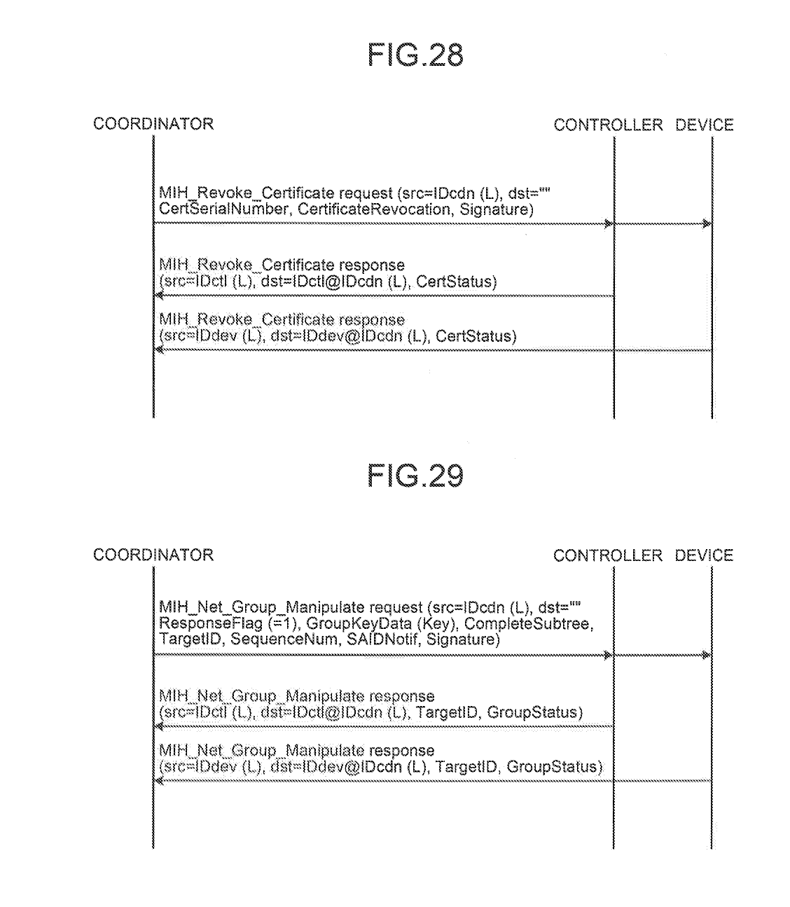

Detailed sequence of certificate revocation FIG. 28 is an example of a detailed sequence of certificate revocation according to the embodiment. As illustrated in FIG. 28, the coordinator 20 transmits an MIH_Revoke_Certificate request message in multicast or in unicast to a controller 30 or a device 40. In response to the message, the controller 30 or the device 40 transmits an MIH_Revoke_Certificate response message to the coordinator 20.

Detailed Sequence of Group Key Update

FIG. 29 is an example of a detailed sequence of group key update according to the embodiment. As illustrated in FIG. 29, the coordinator 20 transmits an MIH_Net_Group_Manipulate request message in multicast or in unicast to a controller 30 or a device 40. In response to the message, the controller 30 or the device 40 transmits an MIH_Net_Group_Manipulate response message to the coordinator 20.

According to the embodiment, since semantics of a group is expressed in the structure of a group identifier and a packet containing a variable value field in which the value is unchanged while the group exits is transmitted and received in the group, it is possible to improve the flexibility of the semantics and to simplify the communication.

Moreover, according to the embodiment, the group manipulation is controlled by using the group manipulation command message which has no signature and to which the authentication code according to the group key corresponding to the individual communication group is attached. Therefore, the processing load can be reduced.

Furthermore, processing procedures, control procedures, specific names, information including various data and parameters, etc., presented in the description or in the drawings may be changed in any manner unless otherwise stated. Furthermore, components of illustrated control devices are represent conceptual functions, and the devices need not necessarily be physically configured as illustrated. Thus, specific forms of distribution or incorporation of devices are not limited to those illustrated but the whole or part thereof can be functionally or physically distributed or incorporated in any units depending on various loads, usage conditions, etc.

Furthermore, the coordinator 20, the controllers 30, and the devices 40 included in the communication system 10 according to the present embodiment can be implemented by using a general-purpose computer system as basic hardware, for example. Programs to be executed have modular configuration including the functions described above. The programs may be recorded on a computer-readable recording medium such as a CD-ROM, a CD-R, or a DVD, in the form of files that can be installed or executed and provided therefrom, or may be embedded in a ROM or the like and provided therefrom.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A communication control device comprising:
a generation unit to generate, in a system using a group key block, a group key corresponding to an individual communication group formed by two communication devices by using an manipulation command including a digital signature of the communication control device; and
a control unit to control a group manipulation of the communication devices by using a group manipulation command message to which an authentication code according to the generated group key is attached.

2. The device according to claim 1, further comprising a determination unit to determine whether or not a communication device forms the individual communication group, wherein
the generation unit generates the group key when it is determined that the communication device forms the individual communication group.

3. The device according to claim 2, wherein the determination unit determines that the group is the individual communication group when the GKB includes two complete subtrees for managing the communication device to which an index identifying each device is assigned and each of the two CSs represents a leaf node of a management tree.

4. The device according to claim 2, wherein the determination unit determines that the communication device forms the individual communication group when a group identifier identifying a group represents the individual communication group.

5. The device according to claim 1, wherein the control unit attaches an authentication code according to the group key when a predetermined message different from the group manipulation command message is used.

6. The device according to claim 1, further comprising an update unit to update a synchronous counter value of a synchronous counter which increases monotonically, wherein
the control unit controls the group manipulation by using the group manipulation command message that includes the synchronous counter value.

7. The device according to claim 6, wherein the update unit updates the synchronous counter value when receiving a synchronous counter update request from the communication device or when losing the synchronous counter in the communication control device.

8. A communication control device comprising:
a communication unit to notify a group member about a synchronous counter that increases monotonically by using a synchronous counter update notification including a digital signature of the communication control device; and
an update unit to update a synchronous counter value of the synchronous counter.

9. The device according to claim 8, wherein the communication unit transmits and receives a message addressed to a group including at least the synchronous counter and a packet counter that is incremented by one every time a message is transmitted in a sequence number.

10. The device according to claim 8 further comprising:
a generation unit to generate a group key corresponding to an individual communication group formed of two communication devices; and
a control unit to control a group manipulation of the communication devices by using a group manipulation command message that includes an authentication code according to the generated group key and the updated synchronous counter value.

11. The device according to claim 8, wherein the update unit updates the synchronous counter value when receiving a synchronous counter update request from the communication device or when losing the synchronous counter in the communication control device.
